(19) United States
(12) Patent Application Publication
(10) Pub. No.: US 2025/0110429 A1
(43) Pub. Date: Apr. 3, 2025

(54) FIXING DEVICE AND IMAGE FORMING SYSTEM USING FIXING DEVICE

(71) Applicant: FUJIFILM Business Innovation Corp., Tokyo (JP)

(72) Inventors: Mitsuhiro MATSUMOTO, Kanagawa (JP); Yasutaka GOTOH, Kanagawa (JP); Kosuke YAMADA, Kanagawa (JP)

(73) Assignee: FUJIFILM Business Innovation Corp., Tokyo (JP)

(21) Appl. No.: 18/612,411

(22) Filed: Mar. 21, 2024

(30) Foreign Application Priority Data
Sep. 28, 2023 (JP) 2023-168650

(51) Int. Cl. G03G 15/20

(52) U.S. Cl. CPC G03G 15/2017; G03G 15/2064; G03G 2215/2016

(57) ABSTRACT

A fixing device heats and pressurizes a medium on which an unfixed image is held and then cools the medium to fix the unfixed image, and includes a heating fixing part that includes a heating source, a belt-like transport fixing part that is stretched and circulatably provided around the heating fixing part and is in contact with an image surface of the medium to transport the medium, a pressure fixing part that is disposed to face the heating fixing part with the transport fixing part interposed therebetween and is pressurized to form a fixing region between the heating fixing part and the pressure fixing part, a cooling unit that is provided in contact with a back of a medium transport region of the transport fixing part on the transport fixing part on a downstream side of the fixing region in a transport direction of the medium and cools the transport fixing part, and a switching unit that switches the transport fixing part and the cooling unit to a contact state or a non-contact state depending on a state where the medium passes through a cooling region of the cooling unit.

### CROSS-REFERENCE TO RELATED APPLICATIONS

This application is based on and claims priority under 35 USC 119 from Japanese Patent Application No. 2023-168650 filed Sep. 28, 2023.

### BACKGROUND

### (i) Technical Field

The present invention relates to a fixing device and an image forming system using the fixing device.

### (ii) Related Art

For example, fixing devices disclosed in JP2012-181337A (Mode for Carrying Out the Invention, FIG. 2), JP2007-163787A (Best Mode for Carrying Out the Invention, FIG. 4), and JP2006-243444A (Best Mode for Carrying Out the Invention, FIG. 4) have already been known as this type of fixing device in the related art.

JP2012-181337A (Mode for Carrying Out the Invention, FIG. 2) discloses a gloss-imparting device that has a cooling mode in which an endless belt is cooled by a heat sink and a non-cooling mode in which the endless belt is not cooled by the heat sink and performs the non-cooling mode during a start-up operation.

JP2007-163787A (Best Mode for Carrying Out the Invention, FIG. 4) discloses a fixing device with a heat sink including a belt drive unit that temporarily stops or decelerates a belt member after a rear end of a recording material passes through a fixing nip region and returns the belt member to an original state before a front end of a subsequent recording material reaches the fixing nip region.

JP2006-243444A (Best Mode for Carrying Out the Invention, FIG. 4) discloses a fixing device having a gloss processing mode in which gloss processing is performed on an image formation surface by cooling a recording medium to which an unfixed toner image is fixed to a predetermined temperature range with a cooling unit while the recording medium is in contact with a fixing belt and a temperature adjustment mode in which the temperature of the cooling unit is adjusted in a start-up state and/or a stand-by state.

### SUMMARY

Aspects of non-limiting embodiments of the present disclosure relate to a fixing device that suppresses wasteful cooling not contributing to the cooling of a medium and ensures fixing performance as compared to a case where a belt-like transport fixing part is continuously cooled in a case where the transport fixing part is heated and cooled to fix an unfixed image formed on a medium, and an image forming system using the fixing device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device that heats and pressurizes a medium on which an unfixed image is held and then cools the medium to fix the unfixed image. The fixing device includes a heating fixing part that includes a heating source, a belt-like transport fixing part that is stretched and circulatably provided around the heating fixing part and is in contact with an image surface of the medium to transport the medium, a pressure fixing part that is disposed to face the heating fixing part with the transport fixing part interposed therebetween and is pressurized to form a fixing region between the heating fixing part and the pressure fixing part, a cooling unit that is provided in contact with a back of a medium transport region of the transport fixing part on the transport fixing part on a downstream side of the fixing region in a transport direction of the medium and cools the transport fixing part, and a switching unit that switches the transport fixing part and the cooling unit to a contact state or a non-contact state depending on a state where the medium passes through a cooling region of the cooling unit.

### BRIEF DESCRIPTION OF THE DRAWINGS

Exemplary embodiment(s) of the present invention will be described in detail based on the following figures, wherein:

FIG. 1A is a diagram showing an overview of an exemplary embodiment of an image forming system into which a fixing device to which the present invention is applied is incorporated, FIG. 1B is a diagram showing a typical aspect of a switching unit shown in FIG. 1A, and FIG. 1C is a diagram showing another typical aspect of the switching unit shown in FIG. 1A;

FIG. 2 is a diagram showing the overall configuration of an image forming system according to a first exemplary embodiment;

FIG. 3 is a diagram showing major parts of a second fixing unit according to the first exemplary embodiment;

FIG. 4A is a diagram showing a dedicated sheet for a photographic image as an example of a medium, FIG. 4B is a diagram showing a state where a toner image is fixed to a dedicated medium, and FIG. 4C is a diagram showing a state where a toner image is fixed to plain paper as an example of a medium;

FIGS. 5A and 5B show major parts of a contact/separation mechanism used in the first exemplary embodiment, FIG. 5A shows a state where a cooler is disposed at a contact position with respect to a transport fixing belt, and FIG. 5B shows a state where the cooler is disposed at a non-contact position with respect to the transport fixing belt;

FIG. 6 is a diagram showing a control system for the second fixing unit according to the first exemplary embodiment and peripheral parts thereof;

FIG. 7 is a flowchart showing a process of contact/separation processing of the cooler that is used in the first exemplary embodiment;

FIG. 8A is a diagram showing a state where the cooler is disposed immediately before a medium enters a cooling region for the second fixing unit, and FIG. 8B is a diagram showing a state where the cooler is disposed immediately after the medium passes through the cooling region for the second fixing unit;

FIG. 9A is a diagram schematically showing a state where a plurality of mediums are transported to the second fixing unit with a predetermined page gap L_{PG}, FIG. 9B is a diagram showing an example of a contact/separation operation of the cooler in a case of “L_{PG}>L_{CA} (the length of a cooling region for the second fixing unit in a transport direction of a medium)”, and FIG. 9C is a diagram showing an example of the contact/separation operation of the cooler in a case of “L_{PG}≤L_{CA}”;

FIG. 10 is a diagram showing major parts of a second fixing unit according to a first modification example;

FIG. 11A is a diagram showing an action of a positioning roller of the first modification example, and FIG. 11B is a diagram showing a secondary problem in a case where the positioning roller is not used;

FIG. 12 is a diagram showing major parts of a second fixing unit according to a second exemplary embodiment;

FIGS. 13A and 13B show major parts of a contact/separation mechanism used in the second exemplary embodiment, FIG. 13A shows a state where the transport fixing belt is disposed at a contact position with respect to the cooler, and FIG. 13B shows a state where the transport fixing belt is disposed at a non-contact position with respect to the cooler;

FIG. 14A is a diagram showing a state where the transport fixing belt is disposed immediately before a medium enters a cooling region for the second fixing unit, and FIG. 14B is a diagram showing a state where the transport fixing belt is disposed immediately after the medium passes through the cooling region for the second fixing unit;

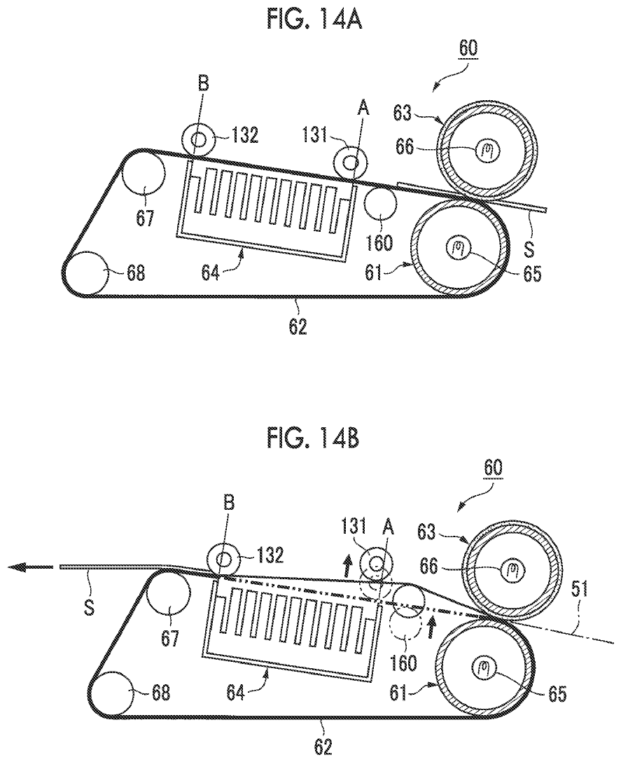

FIG. 15 is a diagram showing major parts of a second fixing unit according to a third exemplary embodiment;

FIG. 16 is a flowchart showing a process of the contact/separation processing of the cooler that is used in the third exemplary embodiment; and

FIG. 17A is a diagram showing a state where a back temperature of a medium when a front end of the medium passes through a middle (D) of a cooling region for the second fixing unit is measured by a temperature sensor, FIG. 17B is a diagram showing an example of a retreat operation of the cooler that is performed in a case where a condition in which a temperature Td measured by the temperature sensor is equal to or lower than a predetermined allowable temperature Tth is satisfied, and FIG. 17C is a diagram showing an example of a retreat operation of the cooler that is performed in a case where a condition of “Td>Tth” is satisfied.

### DETAILED DESCRIPTION

### Overview of Exemplary Embodiment

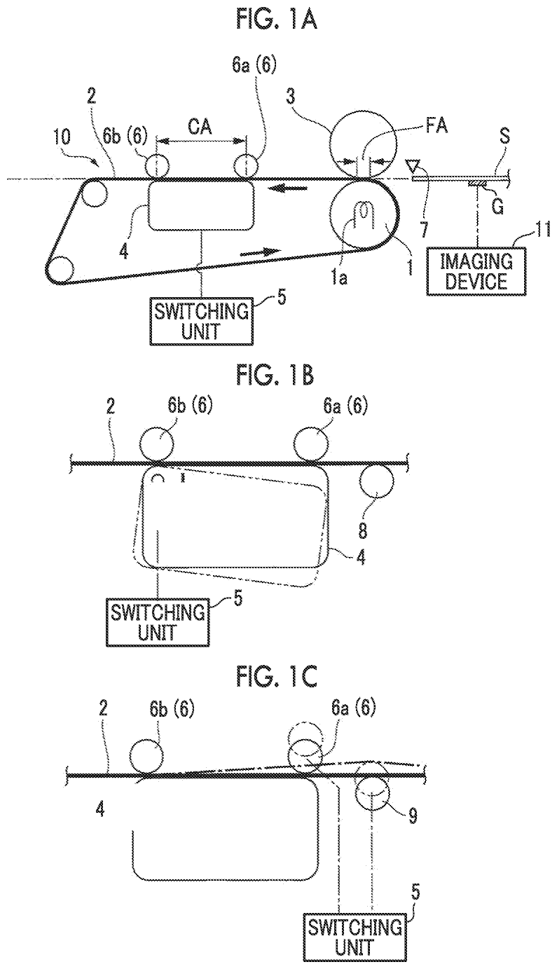

FIG. 1A shows an overview of an exemplary embodiment of an image forming system including a fixing device to which the present invention is applied.

In FIG. 1A, the image forming system includes an imaging device 11 that creates an unfixed image G on a medium S, and a fixing device 10 that fixes the unfixed image G held on the medium S.

Here, the unfixed image refers to an image that is not completely fixed to the medium S, and includes an image that does not pass through a fixing unit prior to the fixing device 10 and an image (temporally fixed) that is incompletely fixed to the medium S since passing through a fixing unit of which a fixing temperature is lowered. For example, “temporally fixed” means a state where a toner image is not embedded in an image receiving layer of the medium S, and includes a case where the toner image is embedded in the image receiving layer of the medium S by being reheated.

Further, the fixing device 10 is a fixing device that heats and pressurizes a medium S on which an unfixed image G is held and then cools the medium S to fix the unfixed image G. The fixing device 10 includes a heating fixing part 1 that includes a heating source 1a, a belt-like transport fixing part 2 that is stretched and circulatably provided around the heating fixing part 1 and is in contact with an image surface of the medium S to transport the medium S, a pressure fixing part 3 that is disposed to face the heating fixing part 1 with the transport fixing part 2 interposed therebetween and is pressurized to form a fixing region FA between the heating fixing part 1 and the pressure fixing part 3, a cooling unit 4 that is provided in contact with a back of a medium transport region of the transport fixing part 2 on the transport fixing part 2 on a downstream side of the fixing region FA in a transport direction of the medium S and cools the transport fixing part 2, and a switching unit 5 that switches the transport fixing part 2 and the cooling unit 4 to a contact state or a non-contact state depending on a state where the medium S passes through a cooling region CA of the cooling unit 4.

In such technical means, the fixing device 10 according to the present exemplary embodiment may be incorporated into an image forming apparatus including the imaging device 11 that creates an unfixed image G, or may be incorporated into a post-processing apparatus separate from the image forming apparatus and configured as an image forming system including a plurality of units.

Further, the heating fixing part 1 includes, for example, a heating fixing roller. The heating source 1a may be either a built-in heating source or an external heating source. Furthermore, the transport fixing part 2 includes a fixing belt. In this example, in order to obtain a high-gloss image, such as a photographic image, it is preferable that the fixing belt is, for example, a belt in which a coating layer having high smoothness, such as fluororubber or silicone rubber, is formed on a surface of an endless film made of a thermosetting polyimide resin. Furthermore, the pressure fixing part 3 may have a roller shape or a belt shape as long as being pressurized to form the fixing region FA between the heating fixing part 1 and the pressure fixing part 3.

Further, the cooling unit 4 may broadly include any unit that is in contact with the back of the medium transport region of the transport fixing part 2 and cools the transport fixing part 2. A heat dissipation unit that dissipates absorbed heat, for example, a heat sink is mostly used as the cooling unit 4. Furthermore, the switching unit 5 may be any unit that uses a state where the medium S passes through the cooling region CA of the cooling unit 4 as a criterion of determination in switching the cooling unit 4 to a contact state where the cooling unit 4 is in contact with the transport fixing part 2 or a non-contact state where the cooling unit 4 is not in contact with the transport fixing part 2.

Next, for example, a typical aspect or a preferable aspect of the fixing device according to the present exemplary embodiment will be described.

First, examples of a typical aspect of the switching unit 5 include an aspect of the switching unit 5 that switches the transport fixing part 2 and the cooling unit 4 to the non-contact state while the medium S does not pass through the cooling region CA of the cooling unit 4 on the transport fixing part 2. This is based on the fact that the cooling of the medium S is performed not over the entire medium transport region of the transport fixing part 2 but in the cooling region CA of the cooling unit 4. That is, since the cooling of the medium S is not necessary while the medium S does not pass through the cooling region CA, cooling processing for the medium S is not affected at all even though an operation for cooling the transport fixing part 2 with the cooling unit 4 is omitted while the medium S does not pass through the cooling region CA.

Accordingly, examples of an aspect of the switching unit 5 include an aspect of the switching unit 5 that switches the cooling unit 4 to the contact state before a front end of the medium S in the transport direction reaches an inlet (upstream start point) of the cooling region CA and switches the cooling unit 4 to the non-contact state when a rear end of the medium S in the transport direction reaches an outlet (downstream end point) of the cooling region CA. In this example, an operation for cooling the transport fixing part 2 with the cooling unit 4 is performed while the medium S passes through the cooling region CA of the cooling unit 4.

Further, an effect of cooling the medium S depends on characteristic information (thickness, thermal conductivity, and the like) of the medium S. For this reason, the medium S may also be cooled up to a predetermined temperature (allowable cooling temperature) before the medium S passes through the cooling region CA of the cooling unit 4.

Examples of an aspect of the switching unit 5 appropriate in such a case include an aspect of the switching unit 5 that switches the cooling unit 4 to the non-contact state in a condition in which the medium S is cooled to a predetermined temperature before the rear end of the medium S in the transport direction reaches the outlet of the cooling region CA. In this example, it is necessary to determine whether or not the medium S, which is passing through the cooling region CA, has been sufficiently cooled on the way. In this case, a temperature detection unit (not shown) that measures the temperature of the medium S (for example, the temperature of the back of a medium S that is not in contact with the transport fixing part 2) may be provided in the middle of the cooling region CA in the transport direction of the medium S. Further, it may be determined whether or not the temperature of the medium S has reached an allowable cooling temperature in response to a detection signal of the temperature detection unit, and the state of the cooling unit 4 may be switched by the switching unit 5.

Furthermore, as a typical configuration example of the switching unit 5, there is an aspect in which the switching unit 5 includes a moving mechanism moving the cooling unit 4 relative to the transport fixing part 2. This moving mechanism includes any of an aspect in which the cooling unit 4 is moved to a non-contact position while being partially in contact with the transport fixing part 2 or an aspect in which the entire cooling unit 4 is moved to a non-contact position.

Here, examples of an aspect of the moving mechanism include an aspect of the moving mechanism that supports the cooling unit 4 to allow the cooling unit 4 to oscillate about an outlet-side end portion or an inlet-side end portion of the cooling region CA of the cooling unit 4 as an oscillation point as shown in FIG. 1B and causes the cooling unit 4 to oscillate between a contact position at which the cooling unit 4 is in contact with the transport fixing part 2 and a retreat position at which the cooling unit 4 retreats from the transport fixing part 2. This example is preferable from the standpoint of, for example, stabilizing a switching operation with a simple configuration as compared to an aspect in which the entire cooling unit 4 is linearly moved in parallel with the transport fixing part 2 to be switched to the contact state or the non-contact state.

Further, in a case where the cooling unit 4 is caused to retreat from the transport fixing part 2 to the retreat position, a gap is formed between the transport fixing part 2 and the cooling unit 4. For this reason, there is a concern that a part of the medium transport region of the transport fixing part 2 may be lowered in a retreat direction. From the standpoint of effectively addressing this type of secondary problem, it is preferable that, for example, a positioning part 8 may be provided on the back of the medium transport region of the transport fixing part 2 as shown in FIG. 1B. The positioning part 8 may be disposed to maintain a surface posture of the medium transport region of the transport fixing part 2 in a case where the entirety or a part of the cooling unit 4 retreats from the contact position at which the cooling unit 4 is in contact with the back of the transport fixing part 2.

Further, as another typical configuration example of the switching unit 5, there is an aspect in which the switching unit 5 includes a moving mechanism moving the transport fixing part 2 relative to the cooling unit 4 as shown in FIG. 1C. This moving mechanism may move the transport fixing part 2 into a state where the entire transport fixing part 2 is not in contact with the cooling unit 4. However, from the standpoint of maintaining the trajectory of an outlet or an inlet of the medium transport region of the transport fixing part 2, it is preferable that, for example, while causing a part of the transport fixing part 2 to be in contact with the cooling unit 4, the moving mechanism moves the remaining part of the transport fixing part 2 in the non-contact state.

As an aspect of this type of moving mechanism, a push-up part 9 may be provided in a region other than the cooling region CA on the back of the medium transport region of the transport fixing part 2 and a portion of the medium transport region of the transport fixing part 2 may be pushed up in a direction away from the cooling unit 4 by the push-up part 9.

In this example, the push-up part 9 may be in contact with or may not be in contact with the transport fixing part 2 before pushing up the transport fixing part 2. Further, in an aspect in which the push-up part 9 is in contact with the transport fixing part 2 before pushing up the transport fixing part 2, the push-up part 9 can also serve as the above-mentioned positioning part 8.

Furthermore, from the standpoint of ensuring a cooling effect of the cooling unit 4, it is preferable that, for example, the medium S transported by the transport fixing part 2 is disposed in close contact with the cooling region CA of the cooling unit 4.

From this standpoint, it is preferable that, for example, an opposing rotating part 6 (specifically, 6a) disposed to face the inlet of the cooling region CA of the cooling unit 4 with the transport fixing part 2 interposed therebetween and rotating while following the transport fixing part 2 is provided as shown in FIGS. 1A to 1C.

Examples of a further preferable aspect include an aspect in which a plurality of opposing rotating parts 6 (specifically, 6a and 6b) disposed to face the inlet of the cooling region CA of the cooling unit 4 and a position (in this example, an outlet) different from the inlet with the transport fixing part 2 interposed therebetween and rotating while following the transport fixing part 2 are provided as shown in FIGS. 1A to 1C.

Further, in an aspect in which the push-up part 9 is provided as the moving mechanism of the switching unit 5, it is preferable that, for example, a part or all of the opposing rotating parts 6 (6a and 6b) are moved in conjunction with the push-up part 9 as shown in FIG. 1C by a virtual line. This example is effective in making the transport fixing part 2 be in the non-contact state where the transport fixing part 2 is not in contact with cooling unit 4 with a push-up operation of the push-up part 9.

Further, from the standpoint of appropriately ascertaining a switching timing of the switching unit 5, it is preferable that, for example, the switching unit 5 includes a position detection unit 7 provided on the upstream side of the fixing region FA in the transport direction of the medium S as shown in FIG. 1A and detecting the position of the front end or the rear end of the medium S in the transport direction, calculates the position of the front end or the rear end of the medium S, which is transported by the transport fixing part 2, in the transport direction on the basis of a detection result of the position detection unit 7, and switches the cooling unit 4 to the contact state or the non-contact state.

In this example, in a case where the position detection unit 7 detects the position of the rear end of the medium S in the transport direction, the switching unit 5 may switch the cooling unit 4 to the non-contact state at a point of time when the rear end of the medium S reaches the outlet of the cooling region CA on the basis of a detection result of the position detection unit 7.

Further, in a case where the position detection unit 7 detects the position of the front end of the medium S in the transport direction, the switching unit 5 may switch the cooling unit 4 to the contact state at a point of time when the front end of the medium S does not yet reach the inlet of the cooling region CA on the basis of a detection result of the position detection unit 7.

Furthermore, although the switching operation of the switching unit 5 is performed depending on a transport position of the medium S, the cooling of a medium S is likely to be insufficient in a case where a distance between a plurality of mediums S (a distance between a rear end of a preceding medium S and a front end of a subsequent medium S) is short. From such a standpoint, examples of an aspect of the switching unit 5 include an aspect of the switching unit 5 that includes a determination unit (not shown) determining a distance between the rear end of a preceding medium in the transport direction and the front end of the subsequent medium in the transport direction and does not perform an operation for switching the cooling unit 4 to the contact state or the non-contact state in a condition in which the distance determined by the determination unit is equal to or shorter than a length of the cooling region CA.

The present invention will be described in more detail on the basis of exemplary embodiments shown in the accompanying drawings.

### First Exemplary Embodiment

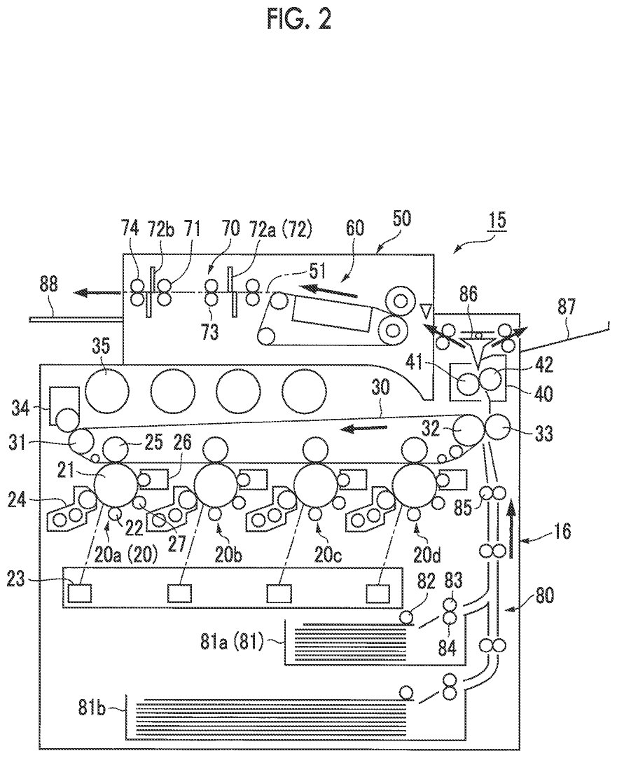

FIG. 2 shows the overall configuration of an image forming system according to a first exemplary embodiment.

### Overall Configuration of Image Forming System

In FIG. 2, the image forming system 15 includes an apparatus body 16 that includes an image forming unit in which color images can be formed, a post-processing apparatus 50 as an optional apparatus is additionally mounted on an upper portion of the apparatus body 16, and a multi-stage medium feed container 81 (81a and 81b) that feeds mediums, such as sheets, are accommodated in a lower portion of the apparatus body 16 to be drawable.

### Image Forming Unit

The image forming unit used in the present exemplary embodiment employs, for example, an electrophotographic method, and has a so-called tandem configuration in which image forming sections 20 (20a to 20d) corresponding to four colors, that is, yellow (Y color), magenta (M color), cyan (C color), and black (K color) are arranged side by side along a belt-like intermediate transfer body 30. For this reason, respective color toner images formed by the respective image forming sections 20 (20a to 20d) are sequentially primarily transferred onto the intermediate transfer body 30 and multiplexed, and this multiplexed toner images are collectively transferred and fixed onto a medium transported from the medium feed container 81. The color arrangement of the image forming sections 20 corresponding to the four colors is not limited to this order, and may be in any other order.

Each of the image forming sections 20 (20a to 20d) of the present exemplary embodiment includes: a photoreceptor 21 as an image holder that forms and holds a toner image corresponding to each color component; a charging part 22 such as a charging roller that charges the photoreceptor 21; an exposure part 23 such as a laser scanner that forms a latent image on the charged photoreceptor 21; a developing part 24 that visualizes the electrostatic latent image formed on the photoreceptor 21; a primary transfer part 25 that primarily transfers the toner image formed on the photoreceptor 21 onto the intermediate transfer body 30 and is formed of, for example, a primary transfer roller; a photoreceptor cleaner 26 that cleans off residual toner remaining on the photoreceptor 21; a charge remover 27 that removes residual charges present on the photoreceptor 21; and the like. Meanwhile, the exposure part 23 in the present exemplary embodiment is adapted such that the exposure of all the image forming sections 20 (20a to 20d) corresponding to the four colors is performed by each exposure part of the image forming sections 20.

Further, the intermediate transfer body 30 is stretched around a plurality of stretching rollers. For example, a stretching roller 31 is a drive roller and is to circularly transport the intermediate transfer body 30, and a stretching roller 32 is disposed to face a secondary transfer part 33, which is formed of, for example, a secondary transfer roller, as a backup roller of the secondary transfer part 33. Furthermore, an intermediate transfer body cleaner 34, which removes residual toner remaining on the intermediate transfer body 30, is provided at a position facing the stretching roller 31 on the intermediate transfer body 30.

In addition, toner boxes 35 corresponding to the four colors that supply toners corresponding to the developing parts 24 of the respective image forming sections 20 are provided above the intermediate transfer body 30 in the apparatus body 16, and supply toners to the developing parts 24 corresponding to the respective colors via transport paths (not shown).

Moreover, a medium transport system 80 of the present exemplary embodiment is as follows. Mediums sent out from each medium feed container 81 by a pickup roller 82 are separated by the action of a feed roller 83 and a retard roller 84 and only one medium is transported to a transport path on the downstream side. Further, registration rollers 85 that position and register the medium transported from the medium feed container 81 before the medium enters the secondary transfer part 33 and a first fixing unit 40 that fixes unfixed toner images transferred onto the medium by the secondary transfer part 33 are provided on the transport path. Furthermore, a switching member 86 is provided on the downstream side of the first fixing unit 40, and the switching member 86 is switched, so that a medium discharged from the first fixing unit 40 is switched to paths in two directions toward the post-processing apparatus 50 and a first discharge tray 87 accommodating a medium directly discharged from the apparatus body 16.

Although two medium feed containers 81a and 81b that accommodate mediums having different sizes are shown as the medium feed container 81, the medium feed container 81 is not limited thereto and three or more medium feed containers may be provided or one medium feed container may be provided. Further, a manual feeder (not shown) may be provided and a medium may be guided from the manual feeder to a transport path.

Furthermore, the first fixing unit 40 of the present exemplary embodiment is, for example, as follows. The first fixing unit 40 includes: a heating fixing roller 41 that includes a heating source (not shown), such as a halogen lamp, therein; and a pressure fixing roller 42 that is disposed to face the heating fixing roller 41, sandwiches a medium in a fixing region formed between the heating fixing roller 41 and the pressure fixing roller 42, and transports the medium.

For this reason, when the medium on which the unfixed toner images are held passes through the fixing region of the first fixing unit 40, the unfixed toner images formed on the medium are fixed onto the medium by heat and pressure. In the present exemplary embodiment, toner images are not completely fixed to the medium, which has passed through the first fixing unit 40 and on which the unfixed toner images are held, by heat and pressure and a fixing operation is adapted to be completed by heating fixing rollers 61 and 63 of a second fixing unit 60 to be described later.

The first fixing unit 40 employs the configuration of a pair of heating pressure rollers in this example, but is not limited thereto. A method in which a pressure pad is disposed to face a heating fixing roller, a pressure belt in conjunction with the heating fixing roller is interposed between the heating fixing roller and the pressure pad, a medium is sandwiched in a fixing region formed between the heating fixing roller and the pressure belt, and an image is fixed to the medium by heat and pressure may be appropriately selected.

### Configuration Example of Post-Processing Apparatus

Further, as shown in FIG. 2, the post-processing apparatus 50 of the present exemplary embodiment includes a second fixing unit 60 that is provided in the middle of a transport path 51 for a medium and makes a toner image surface of the medium highly glossy, and a cutting device 70 that cuts the medium having passed through the second fixing unit 60. In the present exemplary embodiment, a second discharge tray 88 is provided on the downstream side of the post-processing apparatus 50 and the medium having passed through the cutting device 70 is accommodated on the second discharge tray 88.

### Basic Configuration of Second Fixing Unit

The second fixing unit 60 has a basic configuration identical to the configuration of the fixing device 10 shown in FIG. 1A.

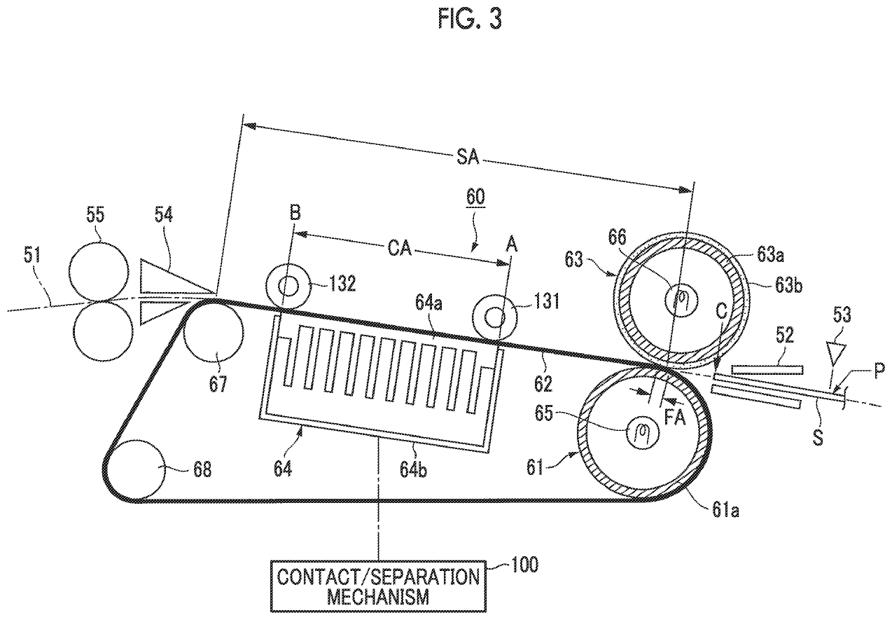

That is, as shown in FIGS. 2 and 3, the second fixing unit 60 includes a heating fixing roller 61 as a heating fixing part, a transport fixing belt 62 as a transport fixing part that is stretched and circulatably provided around the heating fixing roller 61 and is in contact with an image surface of a medium S to transport the medium S, a pressure fixing roller 63 as a pressure fixing part that is disposed to face the heating fixing roller 61 with the transport fixing belt 62 interposed therebetween and is pressurized to form a fixing region FA between the heating fixing roller and the pressure fixing roller 63, and a cooler 64 as a cooling unit that is provided in contact with a back of a medium transport region SA of the transport fixing belt 62 on the transport fixing belt 62 on a downstream side of the fixing region FA in the transport direction of the medium S and cools the transport fixing belt 62.

### Heating Fixing Roller

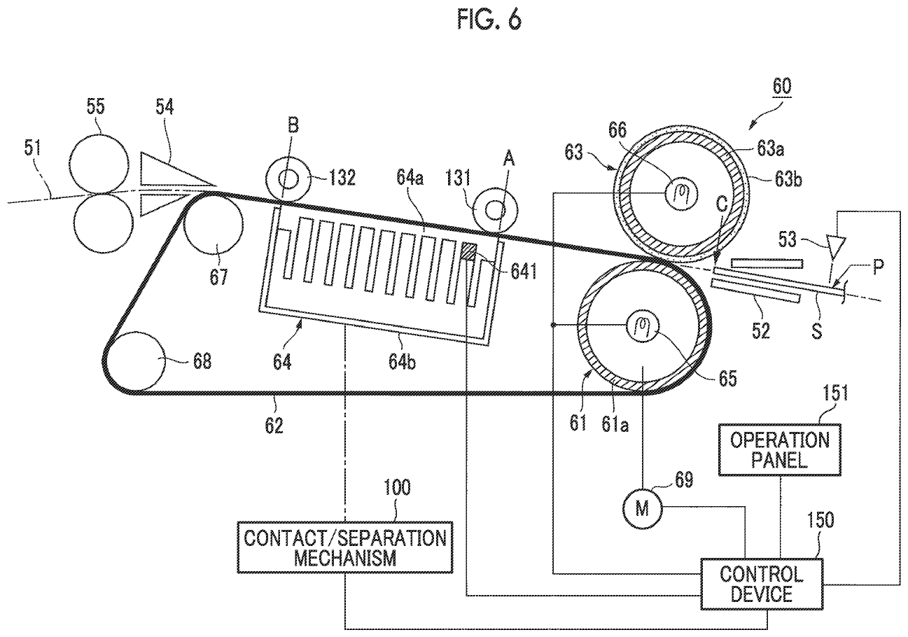

The heating fixing roller 61 has a configuration in which a release layer (not shown) formed of a PFA tube or the like is formed around a core 61a made of a metal having a high thermal conductivity, a heating source 65, such as a halogen lamp, is provided in the core 61a, and heating is controlled so that the surface of the heating fixing roller 61 is heated up to a predetermined temperature by the heating source 65. Further, in the present exemplary embodiment, the heating fixing roller 61 is rotationally driven by a drive motor 69 (see FIG. 6) and the transport fixing belt 62 is circularly rotated by the heating fixing roller 61.

### Transport Fixing Belt

The transport fixing belt 62 is, for example, a belt in which a coating layer having high smoothness, such as fluororubber or silicone rubber, is formed on a surface of an endless film made of a thermosetting polyimide resin. Further, the transport fixing belt 62 is stretched around the heating fixing roller 61, a release roller 67, and a steering roller 68, and is adapted to be capable of being circularly rotated with the rotation of the heating fixing roller 61.

Here, the release roller 67 is rotated while following the movement of the transport fixing belt 62, and the release roller 67 is adapted to suddenly change the movement direction of the transport fixing belt 62 by stretching the transport fixing belt 62 while winding the transport fixing belt 62. For this reason, the medium S on the transport fixing belt 62 is naturally released from the transport fixing belt 62 at a position of the release roller 67 due to the rigidity of the medium S itself. Further, the steering roller 68 is to always tension the transport fixing belt 62 itself. The steering roller 68 presses the transport fixing belt 62 outward to maintain tension and corrects a deviation (a phenomenon in which the transport fixing belt 62 is moved toward any one end portion of the steering roller 68) occurring in a case where the transport fixing belt 62 is circularly moved.

A base material and a coating layer having appropriate thicknesses are selected as a base material and a coating layer of the transport fixing belt 62 to maintain mechanical strength and to effectively use thermal energy. For example, a belt in which a coating layer having a thickness of about 35 μm is formed on a base material having a thickness of about 75 μm is used.

### Pressure Fixing Roller

Meanwhile, in the pressure fixing roller 63, an elastic layer 63b, such as silicone rubber, is coated around a core 63a made of a metal having a high thermal conductivity and a release layer (not shown) identical to the release layer of the heating fixing roller 61 is formed on the surface of the elastic layer 63b. Further, in the present exemplary embodiment, a heating source 66, such as a halogen lamp, is provided even in the core 63a of the pressure fixing roller 63 and heating is controlled so that the surface of the pressure fixing roller 63 is heated up to a predetermined temperature. For this reason, the medium S transported to the second fixing unit 60 is heated and pressurized in the fixing region FA between the heating fixing roller 61 and the pressure fixing roller 63 in a state where the toner image surface of the medium S is in contact with the transport fixing belt 62.

### Cooler

In the present exemplary embodiment, the cooler 64 is provided in contact with the back of the transport fixing belt 62 in a region between the heating fixing roller 61 and the release roller 67 (corresponding to the medium transport region SA). The cooler 64 is in contact with a part of the medium transport region SA of the transport fixing belt 62, and this contact region is referred to as a cooling region CA. That is, the cooler 64 is adapted to cool the transport fixing belt 62 by absorbing heat of the transport fixing belt 62 in the cooling region CA. For this reason, the medium S, which is transported in close contact with the transport fixing belt 62, is cooled.

The cooler 64 in the present exemplary embodiment corresponds to a so-called heat sink. The cooler 64 includes a fin member 64a that is provided with a lot of heat dissipation fins extending in a direction substantially orthogonal to a surface along the transport fixing belt 62, and a cover 64b that is provided to cover the fin member 64a and has the shape of a tube having a rectangular cross-section. Further, this cooler 64 allows air to flow therein by an air blower (not shown) to forcibly dissipate the heat of the fin member 64a.

Meanwhile, a temperature sensor 641 (see FIG. 6) is provided at a part of the fin member 64a, and the cooler 64 is adapted to adjust ON/OFF or air volume of the air blower (not shown) on the basis of a detection result of the temperature sensor 641.

### Peripheral Structure of Second Fixing Unit

Further, in this example, an inlet guide member 52 that guides a medium S to an inlet of the second fixing unit 60 and a position sensor 53 that detects the position of the front end or the rear end of the medium S passing through the transport path 51 are provided near the inlet of the second fixing unit 60.

Furthermore, an outlet guide member 54 that guides the medium S discharged from an outlet of the second fixing unit 60 is provided near the outlet of the second fixing unit 60, and transport rollers 55 are provided on the downstream side of the outlet guide member.

### Selection of Medium

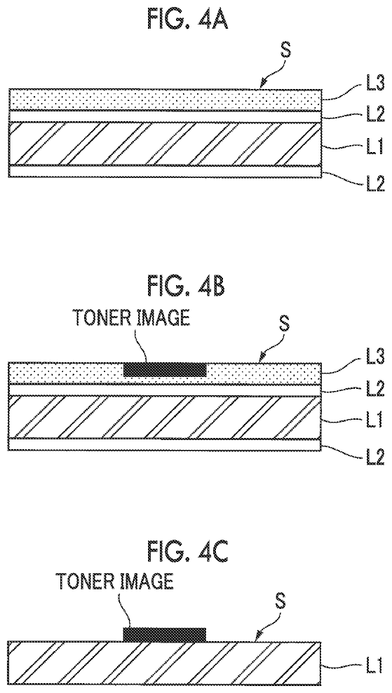

Usually, in order to obtain a high-gloss image, such as a photographic image, it is preferable that, for example, a dedicated sheet shown in FIG. 4A is used as a medium S. As shown in FIG. 4A, the dedicated sheet includes moisture-proof layers L2 on both surfaces of a base material layer L1 and further includes an image receiving layer L3 on a recording surface (toner image formation surface) side.

The moisture-proof layer L2 is made of a resin without air-permeability, such as polyethylene, and a moisture-proof effect of the base material layer L1 is obtained as long as the moisture-proof layer L2 has a thickness of about several μm. Further, for example, the image receiving layer L3 contains a thermoplastic resin, such as polyester having a melting temperature of about 130° C., as a major component, and is formed to have a thickness of 5 to 20 μm, preferably, about 10 μm. Meanwhile, the base material layer L1 has a composition in which cellulose is contained as a major component, and has composition identical to the composition of plain paper. However, for example, a dedicated base material layer L1 having different composition can also be used.

Accordingly, in a case where moisture-proof layers L2 are provided on both surfaces of a base material layer L1 and an image receiving layer L3 made of a material identical to a toner material is further provided as in photographic paper used for a silver halide photograph, it is possible to eliminate air-permeability and to prevent a problem that the base material layer L1 may be stretched to cause curl or a toner image may be stretched to be cracked due to the absorption of moisture in the base material layer L1 under a high-humidity environment. Further, a toner image is melted together with the image receiving layer L3 and pressure is applied to satisfactorily embed the toner image in the image receiving layer L3, so that a smooth printed surface can be obtained.

In a case where fixing is performed using such a dedicated sheet by the second fixing unit 60 in a photographic print mode, the toner image is embedded in the image receiving layer L3 as shown in FIG. 4B. In this case, surface properties of the transport fixing belt 62 of the second fixing unit 60 are copied and the surface of the image receiving layer L3 and the surface of the toner image become substantially uniform, so that a glossy image is obtained. Meanwhile, FIG. 4C shows a state where a toner image is fixed to plain paper as a medium S by only the first fixing unit 40 in a plain paper print mode. In this case, only an image having poor glossiness is obtained since the toner image is placed on the base material layer L1 and the toner image protrudes from the surface of the image.

### Characteristic Configuration of Second Fixing Unit

### Necessity of Contact/Separation Mechanism

In the present exemplary embodiment, the second fixing unit 60 includes a contact/separation mechanism 100 as a switching unit that switches the cooler 64 to a contact state where the cooler 64 is in contact with the transport fixing belt 62 or a non-contact state where the cooler 64 is not in contact with the transport fixing belt 62.

Here, in order to assume a case where the contact/separation mechanism 100 is not provided, a state where the cooler 64 is always in contact with the back of the transport fixing belt 62 is maintained. In this case, the medium S having passed through the fixing region FA between the heating fixing roller 61 and the pressure fixing roller 63 is moved in a state where the medium S is in close contact with the transport fixing belt 62, and is cooled only while the medium S passes through the cooling region CA, with which the cooler 64 is in contact, in the medium transport region SA of the transport fixing belt 62. Accordingly, in a case where the cooler 64 performs a cooling operation in a state where the medium S does not pass through the cooling region CA, not the medium S but only the transport fixing belt 62 is cooled. For this reason, since the temperature of the transport fixing belt 62 is unnecessarily lowered, much power is required for heating in a case where the transport fixing belt 62 is heated again by the heating fixing roller 61. That is, power required for an operation for cooling only the transport fixing belt 62 that does not contribute to the cooling of the medium S is wasted.

In this example, while the medium S does not pass through the cooling region CA of the cooler 64 on the transport fixing belt 62, the transport fixing belt 62 and the cooler 64 are switched to the non-contact state to reduce the waste of power.

### Configuration Example of Contact/Separation Mechanism

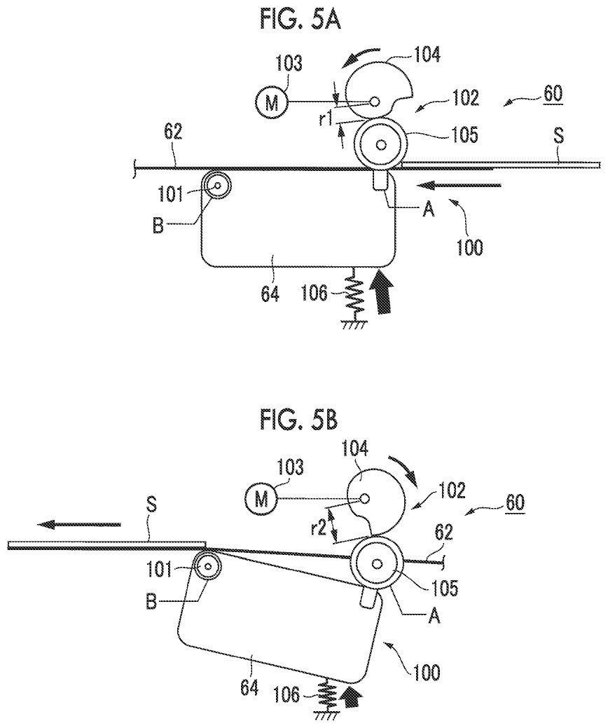

In this example, the contact/separation mechanism 100 calculates a period in which the medium S does not pass through the cooling region CA depending on a state where the medium S passes through the cooling region CA of the cooler 64 as shown in FIGS. 5A and 5B, and moves the cooler 64 from a contact position to a retreat position.

First, the contact/separation mechanism 100 includes an oscillation shaft 101 at an outlet (downstream end point B)-side end portion of the cooling region CA of the cooler 64, and supports the cooler 64 to allow the cooler 64 to oscillate about the oscillation shaft 101 as an oscillation point. The contact/separation mechanism 100 causes the cooler 64 to oscillate between a contact position at which the cooler 64 is in contact with the transport fixing belt 62 and a retreat position at which the cooler 64 retreats in a direction away from the transport fixing belt 62.

The contact/separation mechanism 100 includes a variable mechanism 102 that changes a position of an inlet (upstream start point A)-side end portion of the cooling region CA of the cooler 64 in an oscillation rotation direction as shown in FIGS. 5A and 5B. In this example, the variable mechanism 102 includes an eccentric cam 104 that is rotated by a drive motor 103, cam followers 105 that are rotatably provided on both sides of the inlet of the cooling region CA of the cooler 64 in a width direction and are in contact with a cam surface of the eccentric cam 104, and a bias spring 106 as a bias part that is provided at a free rotating end-side corner of the cooler 64 positioned on a diagonal to the oscillation shaft 101 and biases the cooler 64 toward the transport fixing belt 62.

According to the contact/separation mechanism 100 of this example, in a case where the cooler 64 is to be set to the contact position at which the cooler 64 is in contact with the transport fixing belt 62, for example, the eccentric cam 104 is rotated counterclockwise by the drive motor 103 and a small-diameter portion r1 of the eccentric cam 104 is caused to be in contact with the cam followers 105 by a biasing force of the bias spring 106 as shown in FIG. 5A. Then, the cooler 64 oscillates toward the transport fixing belt 62 about the oscillation shaft 101 as an oscillation point, and is disposed at a predetermined contact position.

On the other hand, in a case where the cooler 64 is caused to retreat to the retreat position, the eccentric cam 104 is rotated clockwise by the drive motor 103 and a large-diameter portion r2 of the eccentric cam 104 is caused to be in contact with the cam followers 105 against the biasing force of the bias spring 106 as shown in FIG. 5B. Then, the cooler 64 oscillates in a direction away from the transport fixing belt 62 about the oscillation shaft 101 as an oscillation point, and is disposed at a predetermined retreat position.

### Close Contact Transportability of Medium

From the standpoint of ensuring a cooling effect of the cooler 64, a technique in which a medium S transported by the transport fixing belt 62 is disposed in close contact with the cooling region CA of the cooler 64 as shown in FIG. 3 has been devised in the present exemplary embodiment.

In this example, an inlet-side opposing roller 131 as an opposing rotating part is provided at a position corresponding to the inlet (upstream start point A) of the cooling region CA of the cooler 64 on a surface side of the transport fixing belt 62. This inlet-side opposing roller 131 is disposed in contact with the transport fixing belt 62, and is rotated while following the transport fixing belt 62.

Further, an outlet-side opposing roller 132 as an opposing rotating part is provided at a position corresponding to the outlet (downstream end point B) of the cooling region CA of the cooler 64 on the surface side of the transport fixing belt 62. This outlet-side opposing roller 132 is disposed in contact with the transport fixing belt 62, and is rotated while following the transport fixing belt 62.

In this example, the inlet-side opposing roller 131 needs to be provided at a position corresponding to the inlet of the cooling region CA. Accordingly, the medium S transported on the transport fixing belt 62 is drawn in by the inlet-side opposing roller 131 at the inlet of the cooling region CA to be in close contact with the transport fixing belt 62.

Meanwhile, the outlet-side opposing roller 132 and the inlet-side opposing roller 131 are effective in causing the medium S to be in close contact with the transport fixing belt 62 at two positions on the front and rear sides in the transport direction of the medium S. However, although the outlet-side opposing roller 132 is provided at a position corresponding to the outlet of the cooling region CA, the outlet-side opposing roller 132 is not limited thereto and may be provided on the upstream side of the outlet of the cooling region CA.

### Control System of Second Fixing Unit

In this example, a control system of the second fixing unit 60 includes a control device 150 that is formed of a microcomputer including various processors as shown in FIG. 6.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

Meanwhile, an operation panel 151 of the image forming system 15 is connected to the control device 150. The operation panel 151 is provided with a start switch (SW) that is used to start imaging processing on a medium S, a mode switch (SW) that is used to designate an imaging mode, such as single-sided printing, two-sided printing, or high-definition printing, a medium type indicating unit that indicates the type of a medium to be used, and the like.

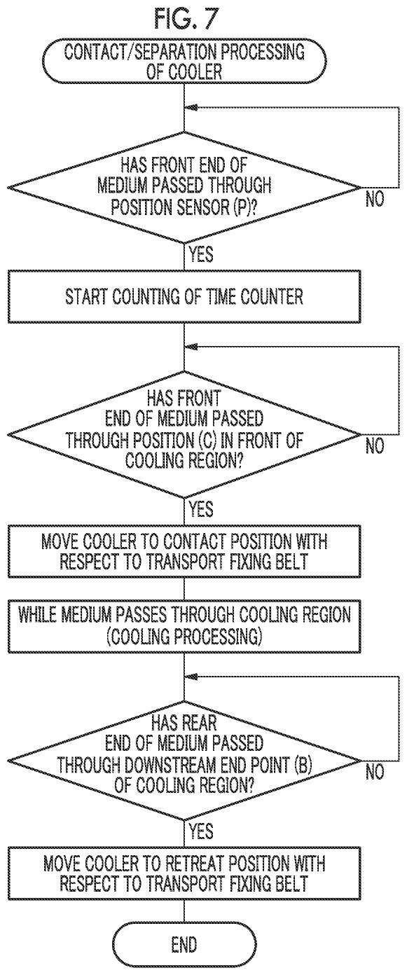

Further, a program related to contact/separation processing of the cooler 64, or the like (for example, see FIG. 7) is installed in advance in an ROM as a storage device of the control device 150. Furthermore, various detectors, such as the position sensor 53 and the temperature sensor 641, are connected to the control device 150. In addition, various control targets (the drive motor 69, the heating sources 65 and 66, the drive motor 103 of the contact/separation mechanism 100, and the like) are connected to the control device 150.

Further, the processors of the control device 150 are adapted to receive instruction signals output from the operation panel 151 and detection signals output from the various detectors, to execute the above-mentioned program, and to send an appropriate control signal to each of the control targets.

### Cutting Device

In the present exemplary embodiment, the cutting device 70 is adapted to be capable of cutting a side of a medium and to produce, for example, a borderless print. For this reason, as shown in FIG. 2, the cutting device 70 includes a slitter 71 that cuts both sides of a medium in a width direction, a plurality of circular cutters 72 (72a and 72b) that cut the medium to a length in a feed direction, and a plurality of transport rollers 73 and 74 that transport the medium. The slitter 71 includes blades of which the number corresponds to the number of cuts required in an axial direction, and is adapted to cut the medium in the feed direction while transporting the medium. Further, the circular cutter 72 is adapted to cut the medium by moving a rolling cutter of an upper blade along a lower blade in a state where the transport of the medium is temporarily stopped. As the circular cutter 72, for example, a roller cutter may be provided in an axial direction and may be adapted to cut the medium while the medium is transported.

Further, the cutting device 70 not only has a function of cutting a medium into a plurality of sheets (for example, four sheets) but also can print one L-size image on a postcard-size medium (100×150 mm) and finish the print without borders. Furthermore, an arbitrary number of L-size digital camera photographs can be obtained from a combination of printing four images on an A4-size medium and printing images on an arbitrary number of postcard-size mediums one by one. Moreover, in a case where the positions of the blades of the slitter 71 in the width direction are made variable, the medium can also be cut into various sizes, such as four pieces, six pieces, and eight pieces.

### Basic Operation of Image Forming System

Next, the basic operation of such an image forming system will be described.

As shown in FIG. 2, multiplexed toner images in which respective color toner images formed by the respective image forming sections 20 (20a to 20d) are multiplexed and which are formed on the intermediate transfer body 30 are collectively transferred onto a medium sent out from the medium feed container 81 by the secondary transfer part 33. After the transferred unfixed toner images are fixed by the first fixing unit 40, the medium is guided to the first discharge tray 87 or guided to the second discharge tray 88 via the post-processing apparatus 50 by the switching member 86.

In the present exemplary embodiment, the switching member 86 switches a medium transport direction as follows. That is, in a plain paper print mode (low-gloss printing) in which a normal image is formed, a medium is discharged to the first discharge tray 87 by the switching member 86 after fixing is performed by the first fixing unit 40. On the other hand, in a photographic print mode (high-gloss printing) in which a high-gloss image, such as a photographic image, is formed, the medium is transported to the second fixing unit 60 by the switching member 86 after fixing is performed by the first fixing unit 40, and the medium is discharged to the second discharge tray 88 via the cutting device 70 after fixing is further performed by the second fixing unit 60. In particular, the cutting device 70 may be used in a case where a borderless print, such as a photographic image, is preferred, and discharges the medium to the second discharge tray 88 without performing cutting in a case where cutting is not particularly necessary.

Usually, in order to obtain a high-gloss image, such as a photographic image, it is preferable that, for example, the dedicated sheet shown in FIG. 4A is used as the medium S.

In a case where fixing is performed using such a dedicated sheet by the second fixing unit 60 in the photographic print mode, the toner image is embedded in the image receiving layer L3 as shown in FIG. 4B. In this case, surface properties of the transport fixing belt 62 of the second fixing unit 60 are copied and the surface of the image receiving layer L3 and the surface of the toner image become substantially uniform, so that a glossy image is obtained.

### Fixing Action of Second Fixing Unit

A fixing action of the second fixing unit 60 is performed as follows.

The medium S guided to the post-processing apparatus 50 via the first fixing unit 40 is to enter the second fixing unit 60 as shown in FIG. 3. In this state, in the second fixing unit 60, the heating fixing roller 61 and the pressure fixing roller 63 are heated up to a temperature at which fixing can be performed by the heating sources 65 and 66, respectively, and the transport fixing belt 62 is circularly rotated with the drive rotation of the heating fixing roller 61.

Further, the cooler 64 is set to the contact position at which the cooler 64 is in contact with the back of the transport fixing belt 62 in a condition in which the front end of the medium S passes through a predetermined reference position C. Then, the cooler 64 drives the air blower to stand ready for a state where the cooling operation is performed.

In this state, after the medium S is subjected to heating/pressure fixing processing in the fixing region FA of the second fixing unit 60 and is transported by the transport fixing belt 62, the medium S is subjected to cooling processing performed by the cooler 64. After that, the medium S is discharged from the second fixing unit 60.

For this reason, in a case where the dedicated sheet shown in FIGS. 4A and 4B is used as the medium S and is subjected to a series of fixing processing in which a medium is subjected to cooling processing after heating/pressurization processing, a high-gloss image, such as a photographic image, can be obtained.

### Contact/Separation Processing of Cooler

In a process in which the fixing processing of the second fixing unit 60 described above is performed, a contact/separation operation of the cooler 64 is performed in parallel in the second fixing unit 60.

The contact/separation processing of the cooler is performed according to, for example, a flowchart shown in FIG. 7.

First, as shown in FIG. 6, the control device 150 detects whether or not the front end of the medium S has passed through a position P of the position sensor 53. In a case where the front end of the medium S has passed through the position P of the position sensor 53, the control device 150 starts a counting operation of a time counter with a detection result of the position sensor 53 as a trigger. Then, the control device 150 determines whether or not the front end of the medium S has passed through a predetermined reference position C in front of the cooling region CA of the cooler 64. The reference position C serves as a reference that is used to move the cooler 64, which is present at the retreat position, to the contact position, and is appropriately selected on the basis of a timing when the movement of the cooler 64 to the contact position is completed before the medium S reaches the inlet of the cooling region CA of the cooler 64.

In this example, a timing when the front end of the medium S passes through the reference position C is determined using a count value of the time counter that uses a detection output of the position sensor 53 as a trigger. However, the present invention is not limited thereto, and an operation for setting the cooler 64 to the contact position can also be directly performed using a detection output of the position sensor 53 in a case where the position P of the position sensor 53 is selected to be the reference position C.

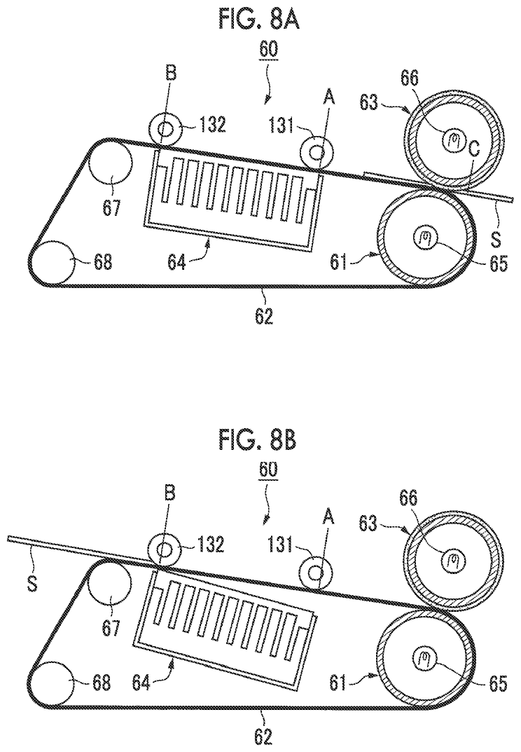

In this example, the control device 150 performs an operation for setting the cooler 64 to the contact position as shown in FIG. 8A according to a procedure shown in FIG. 5A at a timing when the front end of the medium S reaches the reference position C.

Since an operation for setting the cooler 64 to the contact position is completed before the medium S reaches the inlet of the cooling region CA of the cooler 64, the entire medium S is cooled by a cooling action while the medium S passes through the cooling region CA of the cooler 64. After that, the cooled medium S passes through the cooling region CA of the transport fixing belt 62 and is discharged from the second fixing unit 60.

At this time, in a case where the rear end of the medium S passes through the outlet (downstream end point B) of the cooling region, the control device 150 recognizes a timing when the medium S passes through the cooling region CA from a count value of the time counter and performs an operation for causing the cooler 64 to retreat to the retreat position as shown in FIG. 8B according to a procedure shown in FIG. 5B.

As described above, the cooler 64 is set to the contact position while the medium S passes through the cooling region CA of the cooler 64 on the transport fixing belt 62, but the cooler 64 is caused to retreat to the retreat position at which the cooler 64 is not contact with the transport fixing belt 62 while the medium S does not pass through the cooling region CA. For this reason, since it is avoided that the transport fixing belt 62 is unnecessarily cooled by the cooler 64, it is preferable, for example, in terms of being capable of omitting wasteful energy required for the cooling of the cooler 64 and the heating of the heating fixing roller 61 and the pressure fixing roller 63.

Fixing Processing to be Performed by Second Fixing Unit in Case where Plurality of Mediums are Transported

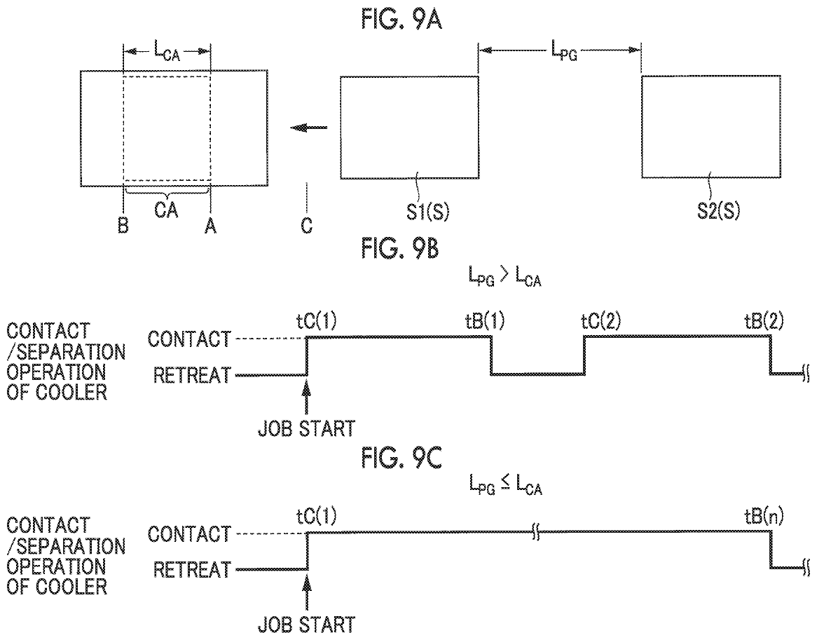

It is conceivable that a plurality of mediums S (S1, S2, . . . ) of an identical type or different types are transported at predetermined intervals as shown in FIG. 9A. In FIG. 9A, L_{CA} denotes a length of the cooling region CA of the cooler 64 in the transport direction of the medium S, and L_{PG} denotes a distance (so-called page gap) between a rear end of the preceding medium S1 and a front end of the subsequent medium S2.

In this case, in a condition in which a page gap L_{PG} exceeds the length L_{CA} of the cooling region CA (L_{PG}>L_{CA}, a condition in which a page gap is ensured to a certain extent), the cooler 64 may be moved from the retreat position to the contact position at timings tC(1), tC(2), . . . when front ends of the respective mediums S (S1, S2, . . . ) pass through the reference position C as shown in FIG. 9B. On the other hand, the cooler 64 may be caused to retreat from the contact position to the retreat position at timings tB(1), tB(2), . . . when rear ends of the respective mediums S (S1, S2, . . . ) pass through the downstream end point B of the cooling region CA.

In contrast, in a case where a method shown in FIG. 9B is to be applied in a condition in which a page gap L_{PG} is equal to or less than the length L_{CA} of the cooling region CA (L_{PG}≤ L_{CA}, a condition in which a page gap is shorter than the cooling region), a substantial action for cooling the medium with the cooler 64 is highly likely to be insufficient. For this reason, in a case of this example, it is preferable that, for example, the contact/separation operation of the cooler 64 is not performed and the cooler 64 is always disposed at the contact position exceptionally as shown in FIG. 9C.

### First Modification Example

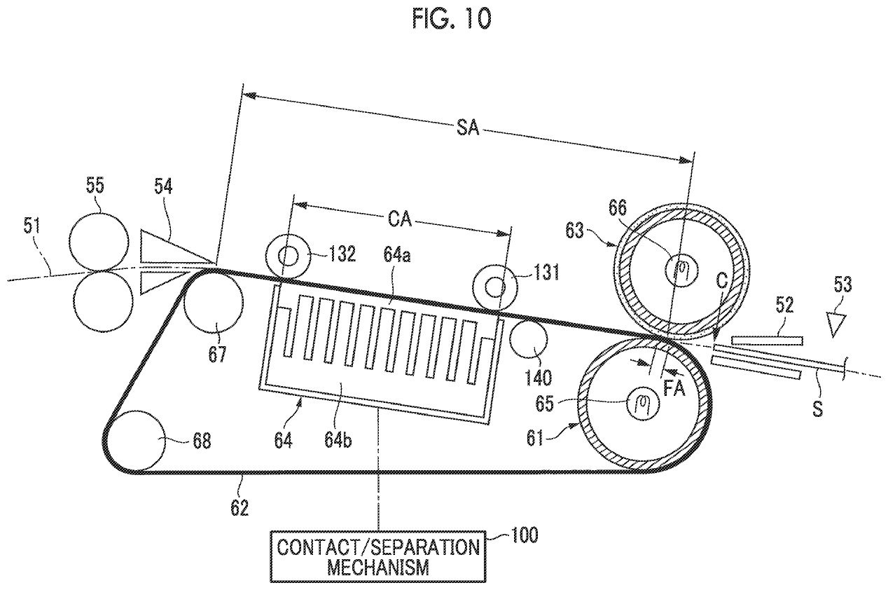

FIG. 10 is a diagram showing major parts of a second fixing unit according to a first modification example.

In FIG. 10, a basic configuration of the second fixing unit is substantially identical to the basic configuration of the second fixing unit of the first exemplary embodiment but a positioning roller 140 is further provided on the back of the transport fixing belt 62 between the inlet (upstream start point A) of the cooling region CA and the fixing region FA. The positioning roller 140 is disposed at a position corresponding to the surface posture (reference posture) of the medium transport region SA of the transport fixing belt 62 in a case where the cooler 64 is set to the contact position.

Components identical to components of the first exemplary embodiment will be denoted by reference numerals identical to the reference numerals of the components of the first exemplary embodiment, and detailed description thereof will be omitted.

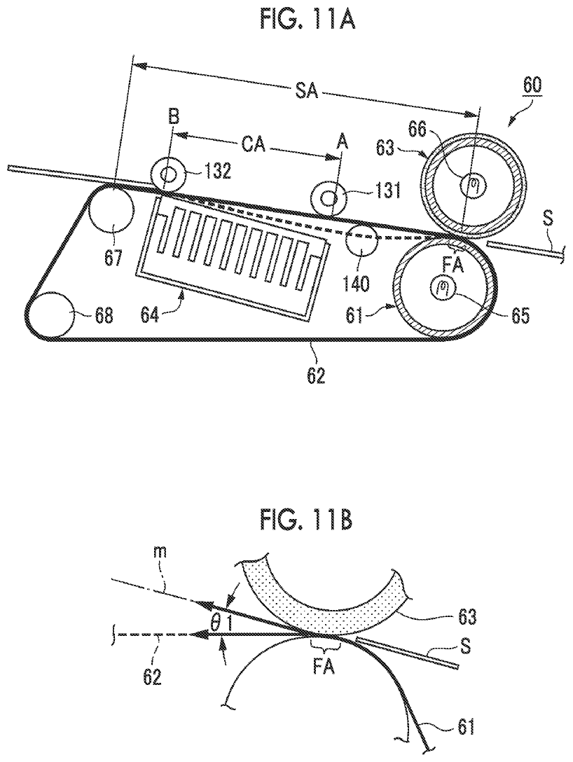

Here, since the positioning roller 140 is not provided in the first exemplary embodiment, a gap is formed between the back of the transport fixing belt 62 and the cooler 64 in a case where the cooler 64 is caused to retreat to the retreat position from the transport fixing belt 62 with the oscillation shaft 101 as an oscillation point as shown in FIG. 11A by a dotted line. In this case, the transport fixing belt 62 not supported by the cooler 64 may sag down in a vertical direction as shown in FIG. 11A by a dotted line. At this time, since an elevation angle θ₁ is formed between the posture (corresponding to a belt travel direction) of the transport fixing belt 62, which is positioned between the fixing region FA and the inlet (upstream start point A) of the cooling region CA, and the above-mentioned reference posture (corresponding to a discharge direction m of a medium passing through the fixing region FA) as shown in FIG. 11B, a medium S is likely to be released from a medium transport surface of the transport fixing belt 62 in a case where a subsequent medium passes through the fixing region FA. In this case, there is a concern that the gloss unevenness of the front end may occur due to the peel-off of the front end of the medium S.

However, since the surface posture of the transport fixing belt 62 is maintained at the reference posture in a case where the positioning roller 140 is provided as in the first modification example, it is preferable, for example, in terms of addressing the above-mentioned problem.

### Second Modification Example

The contact/separation mechanism 100 for the cooler 64 includes the oscillation shaft 101 at the outlet (downstream end point B)-side end portion of the cooling region CA in the present exemplary embodiment, but is not limited thereto. The contact/separation mechanism 100 can include an oscillation shaft at an inlet (upstream start point A)-end portion of the cooling region CA and also allow the cooler 64 to oscillate. In this case, since the surface posture of the transport fixing belt 62 between the inlet of the cooling region CA and the fixing region FA is maintained at the reference posture, it is not necessary to provide the above-mentioned positioning roller.

However, the surface posture of the transport fixing belt 62 between the outlet (downstream end point B) of the cooling region CA and a medium release point (corresponding to the outlet of the medium transport region SA) at which a medium is released by the release roller 67 is likely to be variable. In this case, from the standpoint of satisfactorily maintaining a state where the medium S and the transport fixing belt 62 are in contact with each other between the downstream end point B and the release roller 67, it is preferable to install the above-mentioned positioning roller in, for example, a region in which the surface posture of the transport fixing belt 62 is likely to change.

### Second Exemplary Embodiment

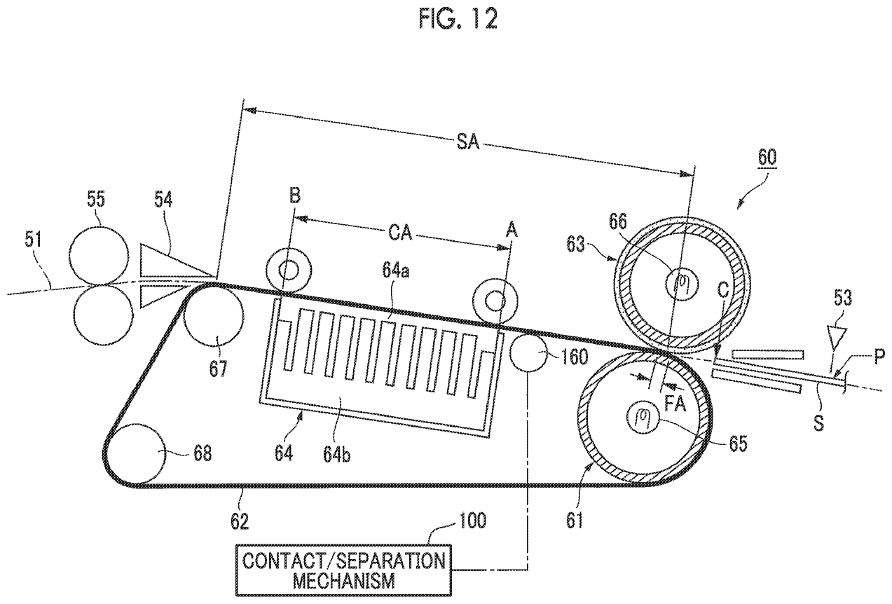

FIG. 12 is a diagram showing major parts of a second fixing unit according to a second exemplary embodiment.

In FIG. 12, a basic configuration of the second fixing unit 60 is substantially identical to the basic configuration of the second fixing unit of the first exemplary embodiment but a contact/separation mechanism 100 different from the contact/separation mechanism of the first exemplary embodiment is provided. Components identical to components of the first exemplary embodiment will be denoted by reference numerals identical to the reference numerals of the components of the first exemplary embodiment, and detailed description thereof will be omitted.

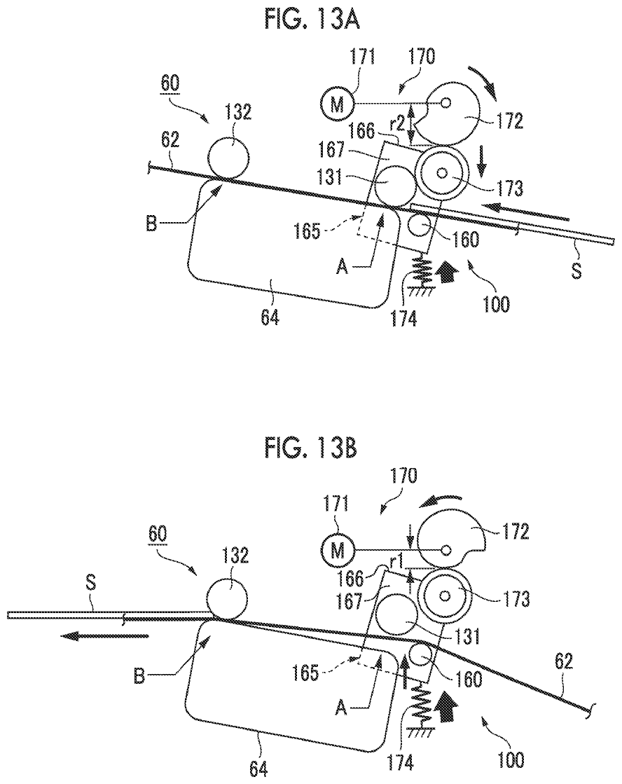

In the second exemplary embodiment, the contact/separation mechanism 100 calculates a period in which a medium S does not pass through a cooling region CA depending on a state where the medium S passes through the cooling region CA of a cooler 64 as shown in FIGS. 13A and 13B, and moves the transport fixing belt 62 from a contact position to a retreat position with respect to the fixedly disposed cooler 64.

In this example, the contact/separation mechanism 100 includes a push-up roller 160 as a push-up part that is provided in a region other than the cooling region CA on the back of the medium transport region SA of the transport fixing belt 62, a connection holder 165 that holds both end shaft portions of the push-up roller 160, and a variable mechanism 170 that changes a position of the connection holder 165 in a thickness direction of the transport fixing belt 62.

A timing of a contact/separation operation of the transport fixing belt 62, which is performed by the contact/separation mechanism 100, is substantially identical to the timing of the contact/separation operation of the cooler 64 shown in the first exemplary embodiment.

In this example, the push-up roller 160 is provided in contact with the back of the transport fixing belt 62 that is positioned between the fixing region FA and the inlet (upstream start point A) of the cooling region CA of the cooler 64.

Further, the connection holder 165 includes a holding frame 166 that extends in the width direction of the transport fixing belt 62 above the transport fixing belt 62, and a pair of holding arms 167 that is suspended from both end portions of the holding frame outside both sides of the transport fixing belt 62 in the width direction.

In this example, both end portions of the push-up roller 160 are rotatably held between the pair of holding arms 167 by the connection holder 165. Further, both end portions of the inlet-side opposing roller are rotatably held between the pair of holding arms 167 by the connection holder 165. Here, the push-up roller 160 and the inlet-side opposing roller 131 are disposed to have a predetermined positional relationship with the transport fixing belt 62 interposed therebetween.

Further, the variable mechanism 170 includes an eccentric cam 172 that is rotated by a drive motor 171, cam followers 173 that are rotatably provided on both sides of the pair of holding arms 167 of the connection holder 165 and are in contact with a cam surface of the eccentric cam 172, and bias springs 174 as bias parts that bias lower end portions of the holding arms 167 of the connection holder 165 toward the transport fixing belt 62.

According to the contact/separation mechanism 100 of this example, in a case where the transport fixing belt 62 is to be set to a contact position at which the transport fixing belt 62 is in contact with the cooler 64, for example, the eccentric cam 172 is rotated clockwise by the drive motor 171 and a large-diameter portion r2 of the eccentric cam 172 is caused to be in contact with the cam followers 173 against biasing forces of the bias springs 174 as shown in FIG. 13A. Then, the variable mechanism 170 pushes down the connection holder 165, so that the push-up roller 160 and the inlet-side opposing roller 131 are pushed down. As a result, the transport fixing belt 62 pushed up by the push-up roller 160 returns to the contact position at which the transport fixing belt 62 is in contact with the cooler 64. In this case, since the transport fixing belt 62 is also pushed down with an operation for pushing down the inlet-side opposing roller 131, the transport fixing belt 62 is in contact with the inlet (upstream start point A) of the cooling region CA of the cooler 64 in a state where the transport fixing belt 62 is in contact with the cooler 64 and is interposed between the inlet-side opposing roller 131 and the cooler 64.

On the other hand, in a case where the transport fixing belt 62 is caused to retreat to the retreat position from the contact position at which the transport fixing belt 62 is in contact with the cooler 64, the eccentric cam 172 is rotated counterclockwise by the drive motor 171 and a small-diameter portion r1 of the eccentric cam 172 is caused to be in contact with the cam followers 173 by biasing forces of the bias springs 174 as shown in FIG. 13B. Then, the connection holder 165 is pushed up by the biasing forces of the bias springs 174. As a result, the push-up roller 160 pushes up the transport fixing belt 62. In this case, the inlet-side opposing roller 131 is also pushed up with a push-up operation of the connection holder 165 while a relative positional relationship between the inlet-side opposing roller 131 and the push-up roller 160 is maintained.

For this reason, the transport fixing belt 62 retreats to a retreat position at which the transport fixing belt 62 is obliquely inclined with respect to a contact position at which the transport fixing belt 62 and the cooler 64 are in contact with each other with an outlet (downstream end point B) portion of the cooling region CA of the cooler 64 as a contact point. There is no concern that the inlet-side opposing roller 131 may be an obstacle in a retreat operation of the transport fixing belt 62.

### Third Exemplary Embodiment

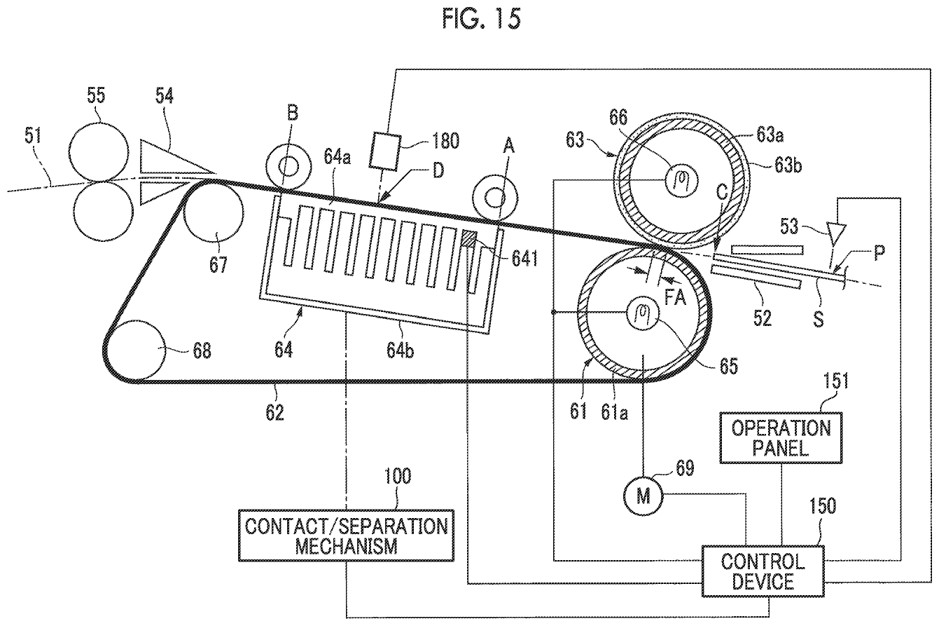

FIG. 15 is a diagram showing major parts of a second fixing unit according to a third exemplary embodiment.

In FIG. 15, a basic configuration of the second fixing unit 60 is substantially identical to the basic configuration of the second fixing unit of the first exemplary embodiment but a cooling effect is further improved on the basis of a situation in which a cooling effect for a medium S is already obtained even while the medium S passes through the cooling region CA of the cooler 64. Components identical to components of the first exemplary embodiment will be denoted by reference numerals identical to the reference numerals of the components of the first exemplary embodiment, and detailed description thereof will be omitted.

### Configuration Example of Contact/Separation Mechanism

In the present exemplary embodiment, a contact/separation mechanism 100 is adapted to allow the cooler 64 to be oscillatable substantially in a manner identical to the manner in the first exemplary embodiment and causes the cooler 64 to oscillate between the contact position and the retreat position with respect to the transport fixing belt 62.

In this aspect, a timing when the cooler 64 is moved from the contact position to the retreat position is identical to that in the first exemplary embodiment.

However, a timing when the cooler 64 is moved from the retreat position to the contact position is different from that in the first exemplary embodiment. That is, a method including measuring a temperature of a medium S, which is passing through the cooling region CA of the cooler 64 and setting a movement timing of the cooler 64 to different timings in a case where the degree of cooling of the medium S is already sufficient and in a case where the degree of cooling of the medium S is not sufficient on the basis of the temperature information is employed in this example.

In this example, a temperature sensor 180 that measures a temperature of the back (corresponding to an upper surface of a medium S in FIG. 15) of the medium S opposite to an image holding surface in a condition in which the medium S is transported in close contact with the transport fixing belt 62 and is passing through the cooling region CA of the cooler 64 is separately provided. The temperature sensor 180 is disposed above the transport fixing belt 62 at a non-contact position at which the temperature sensor 180 is not in contact with the medium S being transported along the transport fixing belt 62. For example, a radiation thermometer or the like is used as the non-contact temperature sensor 180. Further, the temperature sensor 180 sets a middle position of the cooling region CA of the cooler 64 in the medium transport direction on the transport fixing belt 62 as a middle point D and measures a temperature Td of a front end portion of a medium S passing through the middle point D.

In this example, the temperature sensor 180 measures the temperature of the back of the medium S and does not temperature of the surface (image holding surface) of the medium S. For this reason, a temperature distribution in the thickness direction of a medium S differs depending on the thickness, physical properties, or the like of the medium S, and a case where the temperature of the back of a medium S is high is also conceivable depending on the type of a medium S. However, in a case where the temperature of the back of the medium S reaches a temperature equal to or lower than a target temperature (allowable cooling temperature) Tth, it is easily presumed that the temperature of the surface of the medium S being in direct contact with the cooling region CA of the cooler 64 is equal to or lower than the allowable cooling temperature.

Further, in a case where “Td≤Tth (for example, 60° C.)” is satisfied, it is ascertained that cooling processing is completed at a point of time when the medium S passes through the middle point D. In this case, it is presumed that cooling processing for the medium S is completed in a stage where a rear end of the medium S passes through the middle point D. In this state, it is not necessary to continue the cooling processing until the medium S passes through the cooling region CA.

For this reason, a method of starting a retreat operation for causing the cooler 64 to retreat from the contact position to the retreat position at a timing when the rear end of the medium S passes through the middle point D of the cooling region CA is employed in a case where a condition of “Td≤Tth (for example, 60° C.)” is satisfied in this example.

However, a method of starting a retreat operation for causing the cooler 64 to retreat from the contact position to the retreat position at a timing when the rear end of the medium S passes through the outlet (downstream end point B) of the cooling region CA is employed as in the first exemplary embodiment in a case where a condition of “Td>Tth (for example, 60° C.)” is satisfied.

### Contact/Separation Processing of Cooler

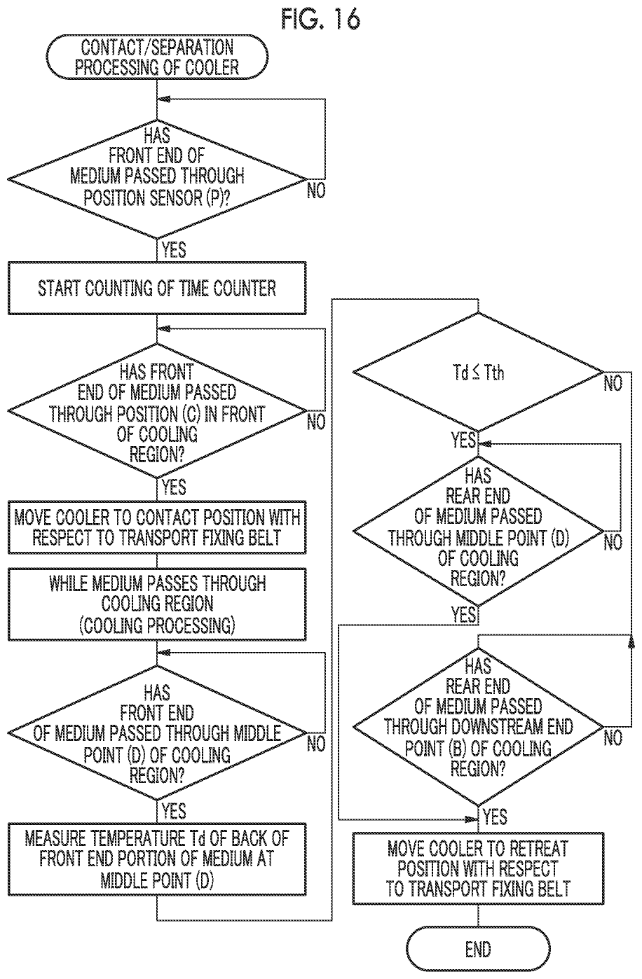

The contact/separation processing of the cooler is performed according to, for example, a flowchart shown in FIG. 16.

First, the control device 150 detects whether or not the front end of the medium S has passed through a position P of the position sensor 53. In a case where the front end of the medium S has passed through the position P of the position sensor 53, the control device 150 starts a counting operation of a time counter with a detection result of the position sensor 53 as a trigger. Then, the control device 150 determines whether or not the front end of the medium S has passed through a predetermined reference position C in front of the cooling region CA of the cooler 64. The reference position C serves as a reference that is used to move the cooler 64, which is present at the retreat position, to the contact position, and is selected in a manner identical to the manner in the first exemplary embodiment.

In this example, a timing when the front end of the medium S passes through the reference position C is determined using a count value of the time counter that uses a detection output of the position sensor 53 as a trigger.

In this example, the control device 150 performs an operation for setting the cooler 64 to the contact position as shown in FIG. 8A according to a procedure shown in FIG. 5A as in the first exemplary embodiment at a timing when the front end of the medium S reaches the reference position C.

Since an operation for setting the cooler 64 to the contact position is completed before the medium S reaches the inlet of the cooling region CA of the cooler 64, the entire medium S is cooled by a cooling action while the medium S passes through the cooling region CA of the cooler 64.

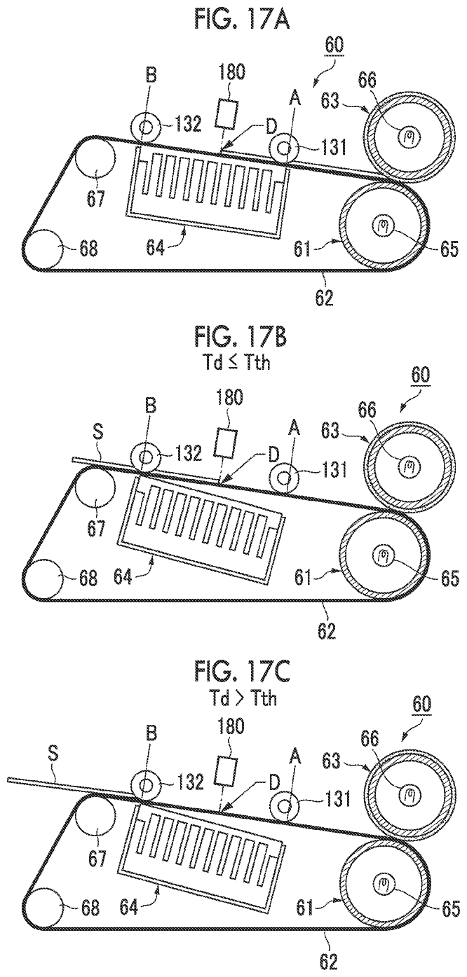

After that, in a case where a front end portion of the medium S reaches the middle point D of the cooling region CA as shown in FIG. 17A, the control device 150 determines a timing when the front end portion of the medium S passes through the middle point D from a count value of the time counter and measures a temperature Td of the back of the front end portion of the medium S with the temperature sensor 180.

In this case, the control device 150 compares the temperature Td, which is measured by the temperature sensor 180, with the allowable cooling temperature Tth (for example, 60° C.) that is a predetermined target temperature.

Then, in a case where the control device 150 determines that a condition of “Td≤ Tth” is satisfied, the control device 150 starts a retreat operation for causing the cooler 64 to retreat from the contact position to the retreat position at a timing when a rear end of the medium S passes through the middle point D of the cooling region CA as shown in FIG. 17B.

On the other hand, in a case where the control device 150 determines that a condition of “Td>Tth (for example, 60° C.)” is satisfied, the control device 150 starts a retreat operation for causing the cooler 64 to retreat from the contact position to the retreat position at a timing when the rear end of the medium S passes through the outlet (downstream end point B) of the cooling region CA as shown in FIG. 17C.

As described above, in the present exemplary embodiment, the second fixing unit 60 has following specific actions in addition to having actions substantially identical to the actions in the first exemplary embodiment.

Specifically, in a case where the medium S is subjected to a sufficient cooling action while the medium S passes through the cooling region CA of the cooler 64, that is, in a case where the medium S reaches a state where the medium S is sufficiently cooled, a retreat operation for causing the cooler 64 to retreat to the retreat position is employed in a stage where the medium S does not yet pass through the cooling region CA. For this reason, a waste that cooling energy unnecessary for the cooling of the medium S is provided for only the cooling of the transport fixing belt 62 can be omitted.

In the present exemplary embodiment, a position at which a temperature is measured by the temperature sensor 180 is the middle point D of the cooling region CA. However, the middle point D is not limited to the middle position of the cooling region CA in the medium transport direction, and may be appropriately selected front and rear regions that sandwich the middle position of the cooling region CA in the medium transport direction.

Further, a contact/separation mechanism substantially identical to the contact/separation mechanism of the first exemplary embodiment is used as the contact/separation mechanism 100 in the present exemplary embodiment, but a contact/separation mechanism substantially identical to the contact/separation mechanism of the second exemplary embodiment can also be used.

### Supplementary Note

(((1)))

A fixing device that heats and pressurizes a medium on which an unfixed image is held and then cools the medium to fix the unfixed image, the fixing device comprising:
a heating fixing part that includes a heating source;
a belt-like transport fixing part that is stretched and circulatably provided around the heating fixing part and is in contact with an image surface of the medium to transport the medium;
a pressure fixing part that is disposed to face the heating fixing part with the transport fixing part interposed therebetween and is pressurized to form a fixing region between the heating fixing part and the pressure fixing part;
a cooling unit that is provided in contact with a back of a medium transport region of the transport fixing part on the transport fixing part on a downstream side of the fixing region in a transport direction of the medium and cools the transport fixing part; and
a switching unit that switches the transport fixing part and the cooling unit to a contact state or a non-contact state depending on a state where the medium passes through a cooling region of the cooling unit.

(((2)))

The fixing device according to (((1))),

wherein the switching unit switches the transport fixing part and the cooling unit to the non-contact state while the medium does not pass through the cooling region of the cooling unit on the transport fixing part.

(((3)))

The fixing device according to (((1))) or (((2))),

wherein the switching unit switches the cooling unit to the contact state before a front end of the medium in the transport direction reaches an inlet of the cooling region and switches the cooling unit to the non-contact state when a rear end of the medium in the transport direction reaches an outlet of the cooling region.

(((4)))

The fixing device according to (((1))) or (((2))),

wherein the switching unit switches the cooling unit to the non-contact state in a condition in which the medium is cooled to a predetermined temperature before a rear end of the medium in the transport direction reaches an outlet of the cooling region.

(((5)))

The fixing device according to any one of (((1))) to (((4))),

wherein the switching unit includes a moving mechanism that moves the cooling unit relative to the transport fixing part.

(((6)))

The fixing device according to (((5))),

wherein the moving mechanism supports the cooling unit to allow the cooling unit to oscillate about an outlet-side end portion or an inlet-side end portion of the cooling region of the cooling unit as an oscillation point and causes the cooling unit to oscillate between a contact position at which the cooling unit is in contact with the transport fixing part and a retreat position at which the cooling unit retreats from the transport fixing part.

(((7)))

The fixing device according to (((5))), further comprising:

a positioning part that is provided on the back of the medium transport region of the transport fixing part and maintains a surface posture of the medium transport region of the transport fixing part in a case where entirety or a part of the cooling unit retreats from the contact position at which the cooling unit is in contact with the back of the transport fixing part.

(((8)))

The fixing device according to any one of (((1))) to (((4))),

wherein the switching unit includes a moving mechanism that moves the transport fixing part relative to the cooling unit.

(((9)))

The fixing device according to (((8))),

wherein the moving mechanism includes a push-up part that is provided in a region other than the cooling region on the back of the medium transport region of the transport fixing part and pushes up a portion of the medium transport region of the transport fixing part in a direction away from the cooling unit.

(((10)))

The fixing device according to any one of (((1))) to (((9))), further comprising:

an opposing rotating part that is disposed to face an inlet of the cooling region of the cooling unit with the transport fixing part interposed therebetween and rotates while following the transport fixing part.

(((11)))

The fixing device according to (((10))), further comprising:

a plurality of opposing rotating parts that are disposed to face the inlet of the cooling region of the cooling unit and a position different from the inlet with the transport fixing part interposed therebetween and rotate while following the transport fixing part.

(((12)))

The fixing device according to (((9))), further comprising:
one or a plurality of opposing rotating parts that are disposed to face an inlet of the cooling region of the cooling unit or are disposed to face the inlet of the cooling region and a position different from the inlet with the transport fixing part interposed therebetween and rotate while following the transport fixing part,
wherein a part or all of the opposing rotating parts are moved in conjunction with the push-up part.

(((13)))

The fixing device according to any one of (((1))) to (((12))),

wherein the switching unit includes a position detection unit that is provided on an upstream side of the fixing region in the transport direction of the medium and detects a position of a front end or a rear end of the medium in the transport direction, calculates the position of the front end or the rear end of the medium that is transported by the transport fixing part in the transport direction on the basis of a detection result of the position detection unit, and switches the cooling unit to the contact state or the non-contact state.

(((14)))

The fixing device according to (((13))),

wherein, in a case where the position detection unit detects the position of the rear end of the medium in the transport direction, the switching unit switches the cooling unit to the non-contact state at a point of time when the rear end of the medium reaches an outlet of the cooling region on the basis of a detection result of the position detection unit.

(((15)))

The fixing device according to (((13))),

wherein, in a case where the position detection unit detects the position of the front end of the medium in the transport direction, the switching unit switches the cooling unit to the contact state at a point of time when the front end of the medium does not yet reach an inlet of the cooling region on the basis of a detection result of the position detection unit.

(((16)))

The fixing device according to any one of (((1))) to (((15))),

wherein the switching unit includes a determination unit that determines a distance between a rear end of a preceding medium in the transport direction and a front end of a subsequent medium in the transport direction, and does not perform an operation for switching the cooling unit to the contact state or the non-contact state in a condition in which the distance determined by the determination unit is equal to or shorter than a length of the cooling region.

(((17)))

An image forming system comprising:
an imaging device that creates an unfixed image on a medium; and
the fixing device according to any one of (((1))) to (((16))) that fixes the unfixed image held on the medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device that heats and pressurizes a medium on which an unfixed image is held and then cools the medium to fix the unfixed image, the fixing device comprising:
a heating fixing part that includes a heating source;
a belt-like transport fixing part that is stretched and circulatably provided around the heating fixing part and is in contact with an image surface of the medium to transport the medium;
a pressure fixing part that is disposed to face the heating fixing part with the transport fixing part interposed therebetween and is pressurized to form a fixing region between the heating fixing part and the pressure fixing part;
a cooling unit that is provided in contact with a back of a medium transport region of the transport fixing part on the transport fixing part on a downstream side of the fixing region in a transport direction of the medium and cools the transport fixing part; and
a switching unit that switches the transport fixing part and the cooling unit to a contact state or a non-contact state depending on a state where the medium passes through a cooling region of the cooling unit.

2. The fixing device according to claim 1,
wherein the switching unit switches the transport fixing part and the cooling unit to the non-contact state while the medium does not pass through the cooling region of the cooling unit on the transport fixing part.

3. The fixing device according to claim 2,
wherein the switching unit switches the cooling unit to the contact state before a front end of the medium in the transport direction reaches an inlet of the cooling region and switches the cooling unit to the non-contact state when a rear end of the medium in the transport direction reaches an outlet of the cooling region.

4. The fixing device according to claim 2,
wherein the switching unit switches the cooling unit to the non-contact state in a condition in which the medium is cooled to a predetermined temperature before a rear end of the medium in the transport direction reaches an outlet of the cooling region.

5. The fixing device according to claim 1,
wherein the switching unit includes a moving mechanism that moves the cooling unit relative to the transport fixing part.

6. The fixing device according to claim 5,
wherein the moving mechanism supports the cooling unit to allow the cooling unit to oscillate about an outlet-side end portion or an inlet-side end portion of the cooling region of the cooling unit as an oscillation point and causes the cooling unit to oscillate between a contact position at which the cooling unit is in contact with the transport fixing part and a retreat position at which the cooling unit retreats from the transport fixing part.

7. The fixing device according to claim 5, further comprising:
a positioning part that is provided on the back of the medium transport region of the transport fixing part and maintains a surface posture of the medium transport region of the transport fixing part in a case where entirety or a part of the cooling unit retreats from the contact position at which the cooling unit is in contact with the back of the transport fixing part.

8. The fixing device according to claim 1,
wherein the switching unit includes a moving mechanism that moves the transport fixing part relative to the cooling unit.

9. The fixing device according to claim 8,
wherein the moving mechanism includes a push-up part that is provided in a region other than the cooling region on the back of the medium transport region of the transport fixing part and pushes up a portion of the medium transport region of the transport fixing part in a direction away from the cooling unit.

10. The fixing device according to claim 1, further comprising:
an opposing rotating part that is disposed to face an inlet of the cooling region of the cooling unit with the transport fixing part interposed therebetween and rotates while following the transport fixing part.

11. The fixing device according to claim 10, further comprising:
a plurality of opposing rotating parts that are disposed to face the inlet of the cooling region of the cooling unit and a position different from the inlet with the transport fixing part interposed therebetween and rotate while following the transport fixing part.

12. The fixing device according to claim 9, further comprising:
one or a plurality of opposing rotating parts that are disposed to face an inlet of the cooling region of the cooling unit or are disposed to face the inlet of the cooling region and a position different from the inlet with the transport fixing part interposed therebetween and rotate while following the transport fixing part,
wherein a part or all of the opposing rotating parts are moved in conjunction with the push-up part.

13. The fixing device according to claim 1,
wherein the switching unit includes a position detection unit that is provided on an upstream side of the fixing region in the transport direction of the medium and detects a position of a front end or a rear end of the medium in the transport direction, calculates the position of the front end or the rear end of the medium that is transported by the transport fixing part in the transport direction on the basis of a detection result of the position detection unit, and switches the cooling unit to the contact state or the non-contact state.

14. The fixing device according to claim 13,
wherein, in a case where the position detection unit detects the position of the rear end of the medium in the transport direction, the switching unit switches the cooling unit to the non-contact state at a point of time when the rear end of the medium reaches an outlet of the cooling region on the basis of a detection result of the position detection unit.

15. The fixing device according to claim 13,
wherein, in a case where the position detection unit detects the position of the front end of the medium in the transport direction, the switching unit switches the cooling unit to the contact state at a point of time when the front end of the medium does not yet reach an inlet of the cooling region on the basis of a detection result of the position detection unit.

16. The fixing device according to claim 1,
wherein the switching unit includes a determination unit that determines a distance between a rear end of a preceding medium in the transport direction and a front end of a subsequent medium in the transport direction, and does not perform an operation for switching the cooling unit to the contact state or the non-contact state in a condition in which the distance determined by the determination unit is equal to or shorter than a length of the cooling region.

17. An image forming system comprising:
an imaging device that creates an unfixed image on a medium; and
the fixing device according to claim 1 that fixes the unfixed image held on the medium.

18. An image forming system comprising:
an imaging device that creates an unfixed image on a medium; and
the fixing device according to claim 2 that fixes the unfixed image held on the medium.

19. An image forming system comprising:
an imaging device that creates an unfixed image on a medium; and
the fixing device according to claim 3 that fixes the unfixed image held on the medium.

20. An image forming system comprising:
an imaging device that creates an unfixed image on a medium; and
the fixing device according to claim 4 that fixes the unfixed image held on the medium.
